(19) United States
(12) Patent Application Publication
(10) Pub. No.: US 2004/0218669 A1
(43) Pub. Date: Nov. 4, 2004

(54) Picture coding method

(75) Inventor: Miska Hannuksela, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/427,737

(22) Filed: Apr. 30, 2003

(51) Int. Cl. H04N 7/12

(52) U.S. Cl. 375/240.01; 375/240.25

(57) ABSTRACT

The invention relates to method for encoding pictures, method for encoding pictures, wherein primary coded pictures and redundant coded pictures of primary coded pictures are formed, each primary coded picture comprising essentially the same picture information as the respective redundant coded picture. At least one of the redundant coded pictures comprises picture information corresponding to only a part of the picture information of the respective primary coded picture. The invention also relates to a system, encoder, decoder, a transmitting device, a receiving device, a software program, a storage medium and a bitstream.

### FIELD OF THE INVENTION

The invention relates to method for encoding pictures, in which primary coded pictures and redundant coded pictures of primary coded pictures are formed. The invention also relates to a system, encoder, decoder, transmitting device, receiving device, software program, a storage medium and a bitstream.

### BACKGROUND OF THE INVENTION

Published video coding standards include ITU-T H.261, ITU-T H.263, ISO/IEC MPEG-1, ISO/IEC MPEG-2, and ISO/IEC MPEG-4 Part 2. These standards are herein referred to as conventional video coding standards.

Video Communication Systems

Video communication systems can be divided into conversational and non-conversational systems. Conversational systems include video conferencing and video telephony. Examples of such systems include ITU-T Recommendations H.320, H.323, and H.324 that specify a video conferencing/telephony system operating in ISDN, IP, and PSTN networks respectively. Conversational systems are characterized by the intent to minimize the end-to-end delay (from audio-video capture to the far-end audio-video presentation) in order to improve the user experience.

Non-conversational systems include playback of stored content, such as Digital Versatile Disks (DVDs) or video files stored in a mass memory of a playback device, digital TV, and streaming.

There is a standardization effort going on in a Joint Video Team (JVT) of ITU-T and ISO/IEC. The work of JVT is based on an earlier standardization project in ITU-T called H.26L. The goal of the JVT standardization is to release the same standard text as ITU-T Recommendation H.264 and ISO/IEC International Standard 14496-10 (MPEG-4 Part 10). The draft standard is referred to as the JVT coding standard in this paper, and the codec according to the draft standard is referred to as the JVT codec.

The codec specification itself distinguishes conceptually between a video coding layer (VCL), and a network abstraction layer (NAL). The VCL contains the signal processing functionality of the codec, things such as transform, quantization, motion search/compensation, and the loop filter. It follows the general concept of most of today's video codecs, a macroblock-based coder that utilizes inter picture prediction with motion compensation, and transform coding of the residual signal. The output of the VCL encoder are slices: a bit string that contains the macroblock data of an integer number of macroblocks, and the information of the slice header (containing the spatial address of the first macroblock in the slice, the initial quantization parameter, and similar). Macroblocks in slices are ordered consecutively in scan order unless a different macroblock allocation is specified, using the so-called Flexible Macroblock Ordering syntax. In-picture prediction is used only within a slice.

The NAL encapsulates the slice output of the VCL into Network Abstraction Layer Units (NALUs), which are suitable for the transmission over packet networks or the use in packet oriented multiplex environments. JVT's Annex B defines an encapsulation process to transmit such NALUs over byte-stream oriented networks.

The optional reference picture selection mode of H.263 and the NEWPRED coding tool of MPEG-4 Part 2 enable selection of the reference frame for motion compensation per each picture segment, e.g., per each slice in H.263. Furthermore, the optional Enhanced Reference Picture Selection mode of H.263 and the JVT coding standard enable selection of the reference frame for each macroblock separately.

Reference picture selection enables many types of temporal scalability schemes. FIG. 1 shows an example of a temporal scalability scheme, which is herein referred to as recursive temporal scalability. The example scheme can be decoded with three constant frame rates. FIG. 2 depicts a scheme referred to as Video Redundancy Coding, where a sequence of pictures is divided into two or more independently coded threads in an interleaved manner. The arrows in these and all the subsequent figures indicate the direction of motion compensation and the values under the frames correspond to the relative capturing and displaying times of the frames.

FIG. 8 shows a block diagram of a general video communications system 800. Due to the fact that uncompressed video requires a huge bandwidth, the input video 801 is compressed in a transmitting device 802 by a source coder 803 to a desired bit rate. The source coder 803 can be divided into two components, namely waveform coder 803.1 and entropy coder 803.2. The waveform coder 803.1 performs lossy video signal compression whereas the entropy coder 803.2 losslessly converts the output of waveform coder 803.1 into a binary sequence. The transport coder 804 encapsulates the compressed video according to the transport protocols in use. It may manipulate the compressed video in other ways too. For example, it may interleave and modulate the data. Then, the data is transmitted to the receiver side via a transmission channel 805 which may comprise server device(s) 806, gateways (not shown) etc. The receiver 807 performs inverse operations to obtain reconstructed video signal for display. The receiver 807 comprises a transport decoder 808 and a source decoder 809. The transport decoder 808 de-capsulates the compressed video input from the transmission channel 805 according to the transport protocols in use. The source decoder 809 can also be divided into two components, namely entropy decoder 809.1 and waveform decoder 809.2. The entropy decoder 809.1 converts the binary sequence from the transport decoder 808 into a waveform to be input to the waveform decoder 809.1. The waveform decoder 809.1 performs video signal decompression and outputs the video signal 810. The receiver 807 may also give feedback to the transmitter. For instance, the receiver may signal the rate of successfully received transmission units.

Parameter Set Concept

One very fundamental design concept of the JVT codec is to generate self-contained packets, to make mechanisms such as the header duplication unnecessary. The way how this was achieved is to decouple information that is relevant to more than one slice from the media stream. This higher layer meta information should be sent reliably, asynchronously and in advance from the RTP packet stream that contains the slice packets. This information can also be sent in-band in such applications that do not have an out-of-band transport channel appropriate for the purpose. The combination of the higher level parameters is called a Parameter Set. The Parameter Set contains information such as picture size, display window, optional coding modes employed, macroblock allocation map, and others.

In order to be able to change picture parameters (such as the picture size), without having the need to transmit Parameter Set updates synchronously to the slice packet stream, the encoder and decoder can maintain a list of more than one Parameter Set. Each slice header contains a codeword that indicates the Parameter Set to be used.

This mechanism allows to decouple the transmission of the Parameter Sets from the packet stream, and transmit them by external means, e.g. as a side effect of the capability exchange, or through a (reliable or unreliable) control protocol. It may even be possible that they get never transmitted but are fixed by an application design specification.

Transmission Order

In conventional video coding standards, the decoding order of pictures is the same as the display order except for B pictures. A block in a conventional B picture can be bi-directionally temporally predicted from two reference pictures, where one reference picture is temporally preceding and the other reference picture is temporally succeeding in display order. Only the latest reference picture in decoding order can succeed the B picture in display order (exception: interlaced coding in H.263 where both field pictures of a temporally subsequent reference frame can precede a B picture in decoding order). A conventional B picture cannot be used as a reference picture for temporal prediction, and therefore a conventional B picture can be disposed without affecting the decoding of any other pictures.

The JVT coding standard includes the following novel technical features compared to earlier standards:

The decoding order of pictures is decoupled from the display order. The picture number indicates decoding order and the picture order count indicates the display order.

Reference pictures for a block in a B picture can either be before or after the B picture in display order. Consequently, a B picture stands for a bi-predictive picture instead of a bi-directional picture.

Pictures that are not used as reference pictures are marked explicitly. A picture of any type (intra, inter, B, etc.) can either be a reference picture or a non-reference picture. (Thus, a B picture can be used as a reference picture for temporal prediction of other pictures.)

A picture can contain slices that are coded with a different coding type. In other words, a coded picture may consist of an intra-coded slice and a B-coded slice, for example.

Decoupling of display order from decoding order can be beneficial from compression efficiency and error resiliency point of view.

An example of a prediction structure potentially improving compression efficiency is presented in FIG. 3. Boxes indicate pictures, capital letters within boxes indicate coding types, numbers within boxes are picture numbers according to the JVT coding standard, and arrows indicate prediction dependencies. Note that picture B17 is a reference picture for pictures B18. Compression efficiency is potentially improved compared to conventional coding, because the reference pictures for pictures B18 are temporally closer compared to conventional coding with PBBP or PBBBP coded picture patterns. Compression efficiency is potentially improved compared to conventional PBP coded picture pattern, because part of reference pictures are bi-directionally predicted. FIG. 4 presents an example of the intra picture postponement method that can be used to improve error resiliency. Conventionally, an intra picture is coded immediately after a scene cut or as a response to an expired intra picture refresh period, for example. In the intra picture postponement method, an intra picture is not coded immediately after a need to code an intra picture arises, but rather a temporally subsequent picture is selected as an intra picture. Each picture between the coded intra picture and the conventional location of an intra picture is predicted from the next temporally subsequent picture. As FIG. 4 shows, the intra picture postponement method generates two independent inter picture prediction chains, whereas conventional coding algorithms produce a single inter picture chain. It is intuitively clear that the two-chain approach is more robust against erasure errors than the one-chain conventional approach. If one chain suffers from a packet loss, the other chain may still be correctly received. In conventional coding, a packet loss always causes error propagation to the rest of the inter picture prediction chain.

Transmission of Multimedia Streams

A multimedia streaming system consists of a streaming server and a number of players, which access the server via a network. The network is typically packet-oriented and provides little or no means to guaranteed quality of service. The players fetch either pre-stored or live multimedia content from the server and play it back in real-time while the content is being downloaded. The type of communication can be either point-to-point or multicast. In point-to-point streaming, the server provides a separate connection for each player. In multicast streaming, the server transmits a single data stream to a number of players, and network elements duplicate the stream only if it is necessary.

When a player has established a connection to a server and requested for a multimedia stream, the server begins to transmit the desired stream. The player does not start playing the stream back immediately, but rather it typically buffers the incoming data for a few seconds. Herein, this buffering is referred to as initial buffering. Initial buffering helps to maintain pauseless playback, because, in case of occasional increased transmission delays or network throughput drops, the player can decode and play buffered data.

In order to avoid unlimited transmission delay, it is uncommon to favor reliable transport protocols in streaming systems. Instead, the systems prefer unreliable transport protocols, such as UDP, which, on one hand, inherit a more stable transmission delay, but, on the other hand, also suffer from data corruption or loss.

RTP and RTCP protocols can be used on top of UDP to control real-time communications. RTP provides means to detect losses of transmission packets, to reassemble the correct order of packets in the receiving end, and to associate a sampling time-stamp with each packet. RTCP conveys information about how large a portion of packets were correctly received, and, therefore, it can be used for flow control purposes.

Transmission Errors

There are two main types of transmission errors, namely bit errors and packet errors. Bit errors are typically associated with a circuit-switched channel, such as a radio access network connection in mobile communications, and they are caused by imperfections of physical channels, such as radio interference. Such imperfections may result into bit inversions, bit insertions and bit deletions in transmitted data. Packet errors are typically caused by elements in packet-switched networks. For example, a packet router may become congested; i.e. it may get too many packets as input and cannot output them at the same rate. In this situation, its buffers overflow, and some packets get lost. Packet duplication and packet delivery in different order than transmitted are also possible but they are typically considered to be less common than packet losses. Packet errors may also be caused by the implementation of the used transport protocol stack. For example, some protocols use checksums that are calculated in the transmitter and encapsulated with source-coded data. If there is a bit inversion error in the data, the receiver cannot end up into the same checksum, and it may have to discard the received packet.

Second (2G) and third generation (3G) mobile networks, including GPRS, UMTS, and CDMA-2000, provide two basic types of radio link connections, acknowledged and non-acknowledged. An acknowledged connection is such that the integrity of a radio link frame is checked by the recipient (either the Mobile Station, MS, or the Base Station Subsystem, BSS), and, in case of a transmission error, a retransmission request is given to the other end of the radio link. Due to link layer retransmission, the originator has to buffer a radio link frame until a positive acknowledgement for the frame is received. In harsh radio conditions, this buffer may overflow and cause data loss. Nevertheless, it has been shown that it is beneficial to use the acknowledged radio link protocol mode for streaming services. A non-acknowledged connection is such that erroneous radio link frames are typically discarded.

Packet losses can either be corrected or concealed. Loss correction refers to the capability to restore lost data perfectly as if no losses had ever been introduced. Loss concealment refers to the capability to conceal the effects of transmission losses so that they should not be visible in the reconstructed video sequence.

When a player detects a packet loss, it may request for a packet retransmission. Because of the initial buffering, the retransmitted packet may be received before its scheduled playback time. Some commercial Internet streaming systems implement retransmission requests using proprietary protocols. Work is going on in IETF to standardize a selective retransmission request mechanism as a part of RTCP.

A common feature for all of these retransmission request protocols is that they are not suitable for multicasting to a large number of players, as the network traffic may increase drastically. Consequently, multicast streaming applications have to rely on non-interactive packet loss control.

Point-to-point streaming systems may also benefit from non-interactive error control techniques. First, some systems may not contain any interactive error control mechanism or they prefer not to have any feedback from players in order to simplify the system. Second, retransmission of lost packets and other forms of interactive error control typically take a larger portion of the transmitted data rate than non-interactive error control methods. Streaming servers have to ensure that interactive error control methods do not reserve a major portion of the available network throughput. In practice, the servers may have to limit the amount of interactive error control operations. Third, transmission delay may limit the number of interactions between the server and the player, as all interactive error control operations for a specific data sample should preferably be done before the data sample is played back.

Non-interactive packet loss control mechanisms can be categorized to forward error control and loss concealment by post-processing. Forward error control refers to techniques in which a transmitter adds such redundancy to transmitted data that receivers can recover at least part of the transmitted data even if there are transmission losses. There are two categories of forward error control methods: signal-dependent and signal-independent. Signal-dependent methods require interpretation of the bitstream. An example of such a method is a repetition of sequence or picture header. Signal-independent methods can be used to recover whatever bitstream regardless of the interpreted content of the bitstream. Examples of such methods are error correction codes (e.g. parity codes and Reed-Solomon codes). Error concealment by post-processing is totally receiver-oriented. These methods try to estimate the correct representation of erroneously received data.

Most video compression algorithms generate temporally predicted INTER or P pictures. As a result, a data loss in one picture causes visible degradation in the consequent pictures that are temporally predicted from the corrupted one. Video communication systems can either conceal the loss in displayed images or freeze the latest correct picture onto the screen until a frame which is independent from the corrupted frame is received.

Primary and Redundant Pictures

A primary coded picture is a primary coded representation of a picture. The decoded primary coded picture covers the entire picture area, i.e., the primary coded picture contains all slices and macroblocks of the picture. A redundant coded picture is a redundant coded representation of a picture that is not used for decoding unless the primary coded picture is missing or corrupted. A decoded redundant coded picture contains essentially the same picture information as the respective decoded primary coded picture. However, the sample values in a decoded redundant coded picture are not required to be exactly equal to the co-located sample values in the corresponding decoded primary coded picture. The number of redundant coded pictures per a primary coded picture may range from 0 to a limit specified in a coding standard (e.g. to 127 according to the JVT coding standard). A redundant coded picture may use different reference pictures compared to the respective primary coded picture. Thus, if one of the reference pictures of the primary coded picture is missing or corrupted and all the reference pictures of a corresponding redundant coded picture are correctly decoded, it is advantageous from the picture quality point of view to decode the redundant coded picture instead of the primary coded picture.

Most conventional video coding standards include a concept of “not coded” or “skipped” macroblocks. The decoding process of such a macroblock consists of a copy of the spatially corresponding macroblock in the reference picture.

Object-Based Coding According to MPEG-4 Visual

MPEG-4 Visual includes optional object-based coding tools. MPEG-4 video objects may be of any shape, and furthermore the shape, size, and position of the object may vary from one frame to the next. In terms of its general representation, a video object is composed of three color components (YUV) and an alpha component. The alpha component defines the object's shape on an image-by-image basis. Binary objects form the simplest class of object. They are represented by a sequence of binary alpha maps, i.e., 2-D images where each pixel is either black or white. MPEG-4 provides a binary shape only mode for compressing these objects. The compression process is defined exclusively by a binary shape encoder for coding the sequence of alpha maps. In addition to the sequence of binary alpha maps representing the object shape, the representation comprises the colors of all the pixels within the interior of the object shape. MPEG-4 encodes these objects using a binary shape encoder and then a motion compensated discrete cosine transform (DCT)-based algorithm for the interior texture coding. Finally, it is possible to represent a textured object with gray-level shape. For this object, the alpha map is a gray-level image with 256 possible levels. This gray-level alpha information is used to specify an object's transparency characteristics during the video composition process. MPEG-4 encodes these objects using a binary shape encoder for the support of the alpha map and a motion compensated DCT-based algorithm for the coding of the alpha map and the interior texture.

Buffering

Streaming clients typically have a receiver buffer that is capable of storing a relatively large amount of data. Initially, when a streaming session is established, a client does not start playing the stream back immediately, but rather it typically buffers the incoming data for a few seconds. This buffering helps to maintain continuous playback, because, in case of occasional increased transmission delays or network throughput drops, the client can decode and play buffered data. Otherwise, without initial buffering, the client has to freeze the display, stop decoding, and wait for incoming data. The buffering is also necessary for either automatic or selective retransmission in any protocol level. If any part of a picture is lost, a retransmission mechanism may be used to resend the lost data. If the retransmitted data is received before its scheduled decoding or playback time, the loss is perfectly recovered.

Coded pictures can be ranked according to their importance in the subjective quality of the decoded sequence. For example, non-reference pictures, such as conventional B pictures, are subjectively least important, because their absence does not affect decoding of any other pictures. Subjective ranking can also be made on data partition or slice group basis. Coded slices and data partitions that are subjectively the most important can be sent earlier than their decoding order indicates, whereas coded slices and data partitions that are subjectively the least important can be sent later than their natural coding order indicates. Consequently, any retransmitted parts of the most important slice and data partitions are more likely to be received before their scheduled decoding or playback time compared to the least important slices and data partitions.

Identification of Redundant Pictures

Due to the fact that there are no picture headers in the JVT coding syntax, the slice header syntax has to provide means to detect picture boundaries to let decoders operate on picture basis. If a decoder conformant to the JVT coding standard receives an error-free bitstream that includes both primary and redundant coded pictures, the decoder must detect the boundaries of primary and redundant coded pictures and decode only the primary coded pictures in order to reconstruct the sample values exactly as required in the standard. Moreover, if redundant pictures are conveyed over a connectionless channel such as RTP/UDP/IP, each one of them may be encapsulated to more than one IP packet. Because of the connectionless nature of UDP, the packets may be received in different order from the one they were transmitted. Thus, the receiver has to deduce which coded slices belong to redundant coded pictures and which ones belong to primary coded pictures, and which redundant coded pictures correspond to a particular primary coded picture. If the receiver did not do this, slices overlapping with each other could be decoded unnecessarily.

### SUMMARY OF THE INVENTION

A redundant coded representation of a picture can be used to provide unequal error protection in error-prone video transmission. If a primary coded representation of a picture is not received, a redundant representation can be used. If one of the reference pictures of the primary coded picture is missing or corrupted and all the reference pictures of a corresponding redundant coded picture are correctly decoded, the redundant coded picture can be decoded. Many times the subjective importance of different spatial parts of a picture can vary. The invention enables transmission of incomplete redundant pictures that do not cover the entire picture area. Consequently, the invention enables protection of only the subjectively most important parts of selected pictures. This improves compression efficiency compared to earlier standards and allows spatial focusing of unequal error protection.

In the following description the invention is described by using encoder-decoder based system, but it is obvious that the invention can also be implemented in systems in which the video signals are stored. The stored video signals can be either uncoded signals stored before encoding, as encoded signals stored after encoding, or as decoded signals stored after encoding and decoding process. For example, an encoder produces bitstreams in decoding order. A file system receives audio and/or video bitstreams which are encapsulated e.g. in decoding order and stored as a file. In addition, the encoder and the file system can produce metadata which informs subjective importance of the pictures and NAL units, contains information on sub-sequences, inter alia. The file can be stored into a database from which a direct playback server can read the NAL units and encapsulate them into RTP packets. According to the optional metadata and the data connection in use, the direct playback server can modify the transmission order of the packets different from the decoding order, remove sub-sequences, decide what SEI messages will be transmitted, if any, etc. In the receiving end the RTP packets are received and buffered. Typically, the NAL units are first reordered into correct order and after that the NAL units are delivered to the decoder.

Some networks or inter-networks and/or the communication protocols used in these networks for video communication may be constructed such that a sub-network is error-prone whereas another sub-network provides essentially error-free link. For example, if a mobile terminal connects to a streaming server that resides on a public IP-based network, reliable link layer protocols may be used in the radio link and the private mobile operator core network may be over-provisioned such that the sub-network controlled by the mobile operator is essentially error-free. However, the public IP-based network (e.g. the Internet) provides an error-prone best-effort service. Consequently, protection against transmission errors should be used in the error-prone sub-network, whereas application-level error protection is not useful in a sub-network providing essentially error-free connection. In such a situation, it is beneficial to have a gateway component connecting the error-prone sub-network to the error-free sub-network. The gateway preferably analyzes the bitstream transmitted from a terminal connected to the error-prone sub-network to a terminal connected to the error-free sub-network. If no errors have hit a particular part of the bitstream, the gateway preferably removes the application-level redundancy for forward error control that corresponds to that part of the bitstream. This operation reduces the amount of traffic in the error-free network, and the saved amount of traffic can then be used for other purposes.

The encoding method according to the present invention is primarily characterized in that each primary coded picture comprising essentially the same picture information as the respective redundant coded picture, and at least one of the redundant coded pictures comprises picture information corresponding to only a part of the picture information of the respective primary coded picture. The decoding method according to the present invention is primarily characterized in that the primary coded pictures having been formed using essentially the same picture information as what has been used to form the respective redundant coded pictures, and at least one of the redundant coded pictures comprises picture information corresponding to only a part of the picture information of the respective primary coded picture; detecting in the bitstream a parameter indicating that the coded picture information belongs to a redundant coded picture; using the parameter to control the decoding of the coded picture information belonging to a redundant coded picture wherein the redundant coded picture information corresponds to only a part of the picture information used to form the respective primary coded picture. The system according to the present invention is primarily characterized in that the encoder comprises encoding means for forming primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture; and the decoder comprises detecting means for detecting in the bitstream a parameter indicating that the coded picture information belongs to a redundant coded picture; and controlling means using the parameter to control the decoding of the coded picture information belonging to a redundant coded picture wherein the redundant coded picture information corresponds to only a part of the picture information used to form the respective primary coded picture. The encoder according to the present invention is primarily characterized in that the encoder comprises encoding means for forming primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture. The decoder according to the present invention is primarily characterized in that the decoder comprises detecting means for detecting in the bitstream a parameter indicating that the coded picture information belongs to a redundant coded picture; and controlling means using the parameter to control the decoding of the coded picture information belonging to a redundant coded picture wherein the redundant coded picture information corresponds to only a part of the picture information used to form the respective primary coded picture. The software program for encoding according to the present invention is primarily characterized in that it comprises machine executable steps for encoding pictures, comprising machine executable steps for forming primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture. The software program for decoding according to the present invention is primarily characterized in that it comprises machine executable steps for detecting in the bitstream a parameter indicating that the coded picture information belongs to a redundant coded picture; and using the parameter to control the decoding of the coded picture information belonging to a redundant coded picture wherein the redundant coded picture information corresponds to only a part of the picture information used to form the respective primary coded picture. The storage medium for storing a software program comprising machine executable steps for encoding pictures according to the present invention is primarily characterized in that primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture. The transmitting device according to the present invention is primarily characterized in that it comprises an encoder for encoding pictures, comprising encoding means for forming primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture. The receiving device according to the present invention is primarily characterized in that it comprises a decoder comprising detecting means for detecting in the bitstream a parameter indicating that the coded picture information belongs to a redundant coded picture; and controlling means using the parameter to control the decoding of the coded picture information belonging to a redundant coded picture wherein the redundant coded picture information corresponds to only a part of the picture information used to form the respective primary coded picture. The bitstream according to the present invention is primarily characterized in that it comprises primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture.

The present invention enables decoders to detect boundaries between primary and redundant coded pictures and to avoid unnecessary decoding of redundant coded pictures if the primary coded picture is correctly decoded.

The present invention improves the reliability of the coding systems. By using the present invention the correct decoding order of the pictures can be more reliably determined than in prior art systems even if some packets of a video stream are not available in the decoder.

### DESCRIPTION OF THE DRAWINGS

FIG. 1 shows an example of a recursive temporal scalability scheme,

FIG. 2 depicts a scheme referred to as Video Redundancy Coding, where a sequence of pictures is divided into two or more independently coded threads in an interleaved manner,

FIG. 3 presents an example of a prediction structure potentially improving compression efficiency,

FIG. 4 presents an example of the intra picture postponement method that can be used to improve error resiliency,

FIG. 5 depicts an advantageous embodiment of the system according to the present invention,

FIG. 6 depicts an advantageous embodiment of the encoder according to the present invention,

FIG. 7 depicts an advantageous embodiment of the decoder according to the present invention,

FIG. 8 shows a block diagram of a general video communications system.

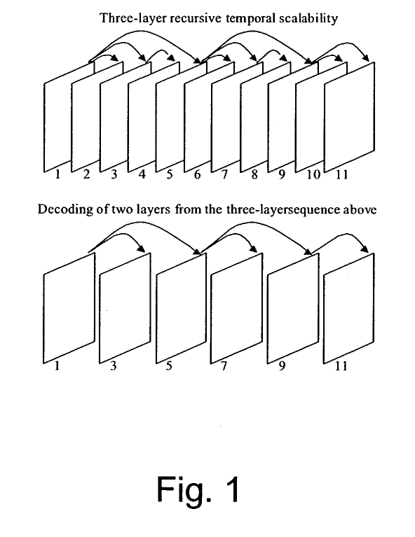

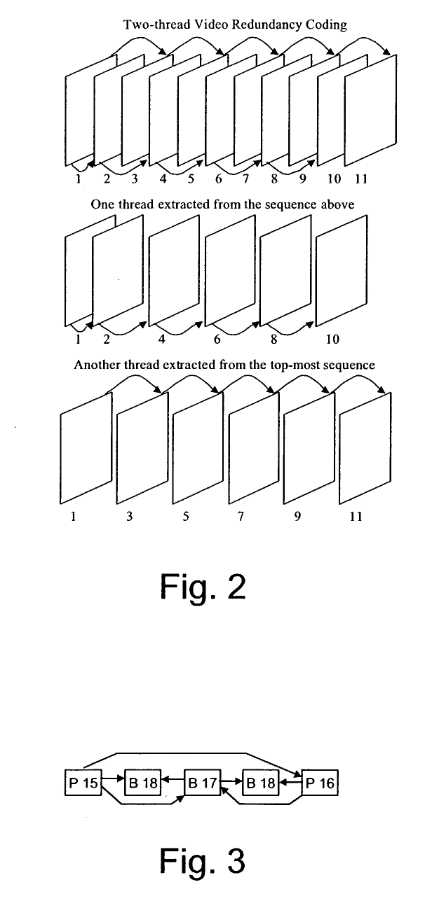

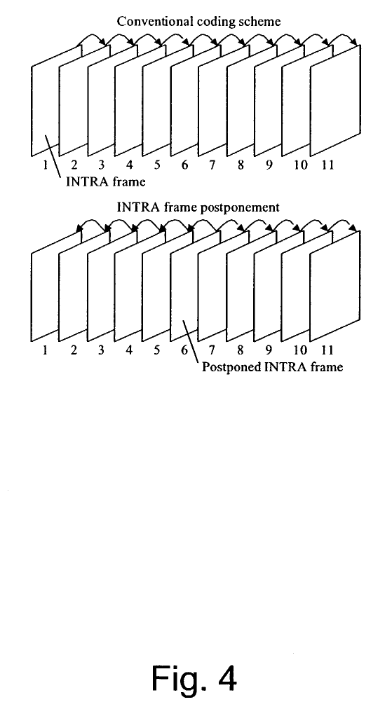

### DETAILED DESCRIPTION OF THE INVENTION

For consistency and clarity, the following definitions related to primary coded and redundant coded slices are defined for use of the description of the invention:

Slice data partitioning is a method of partitioning the syntax elements of the slice syntax structure into slice data partition syntax structures based on the type of each syntax element. In the JVT coding standard, there are three slice data partition syntax structures: slice data partition A, B, and C. Slice data partition A contains all syntax elements in the slice header and slice data syntax structures other than the syntax elements for coding the difference between the predicted sample values and the decoded sample values. Slice data partition B contains the syntax elements for coding the difference between the predicted sample values and the decoded sample values in intra macroblock types (I and SI macroblocks). Slice data partition C contains the syntax elements for coding the difference between the predicted sample values and the decoded sample values in inter-predicted macroblock types (P, SP, and B macroblocks).

Primary coded data partition is a data partition which belongs to a primary coded picture.

Primary coded picture is a primary coded representation of a picture.

Primary coded slice is a slice which belongs to a primary coded picture.

Redundant coded data partition is a data partition which belongs to a redundant coded picture.

Redundant coded picture is a redundant coded representation of a picture that should only be used if the primary coded or decoded picture is corrupted. The decoded redundant picture may not cover the entire picture area. There should be no noticeable difference between the co-located areas of the decoded primary picture and any decoded redundant slices. The redundant coded picture is not required to contain all macroblocks in the primary coded picture.

Redundant coded slice is a slice belonging to a redundant coded picture.

There are two major differences between “not coded” macroblocks and the macroblocks that are not included in a redundant picture: First, macroblocks that are not included in a redundant coded picture are not signaled, whereas “not coded” macroblocks are coded in the bitstream (typically by one bit per “not coded” macroblock). Second, decoders must not decode the areas not included in a redundant picture. If any macroblock is not included in the received primary coded picture or any corresponding redundant coded picture, decoders should conceal these missing macroblocks using any proprietary error concealment algorithm. In contrast to this, there is a specific normative decoding process for “not coded” macroblocks.

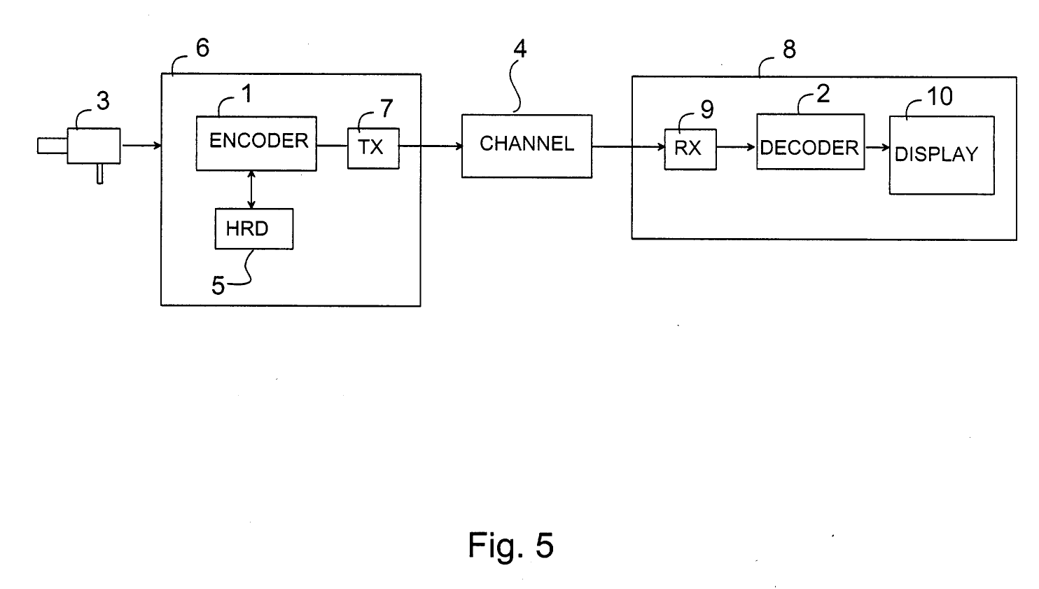

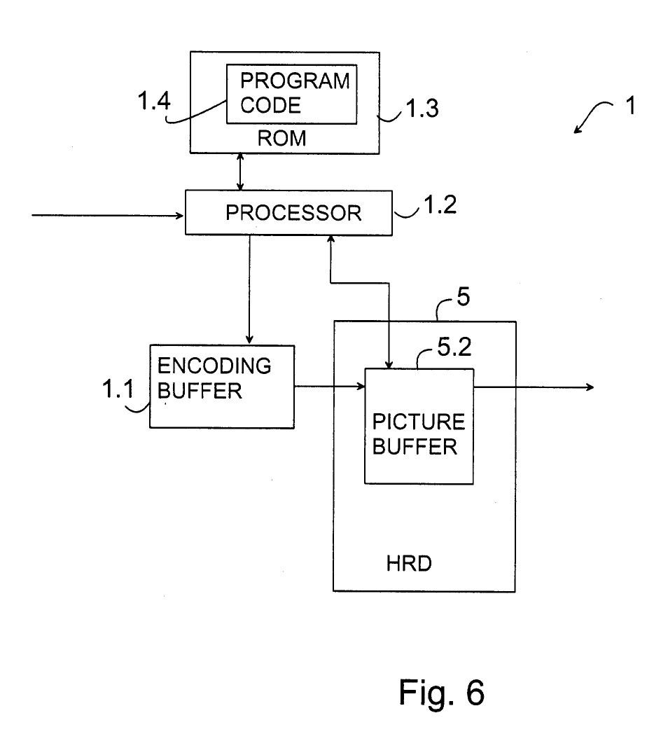

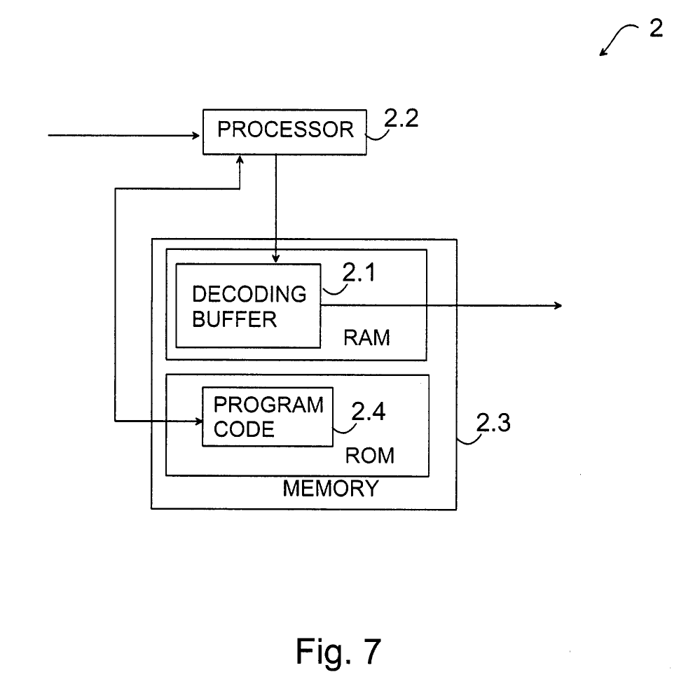

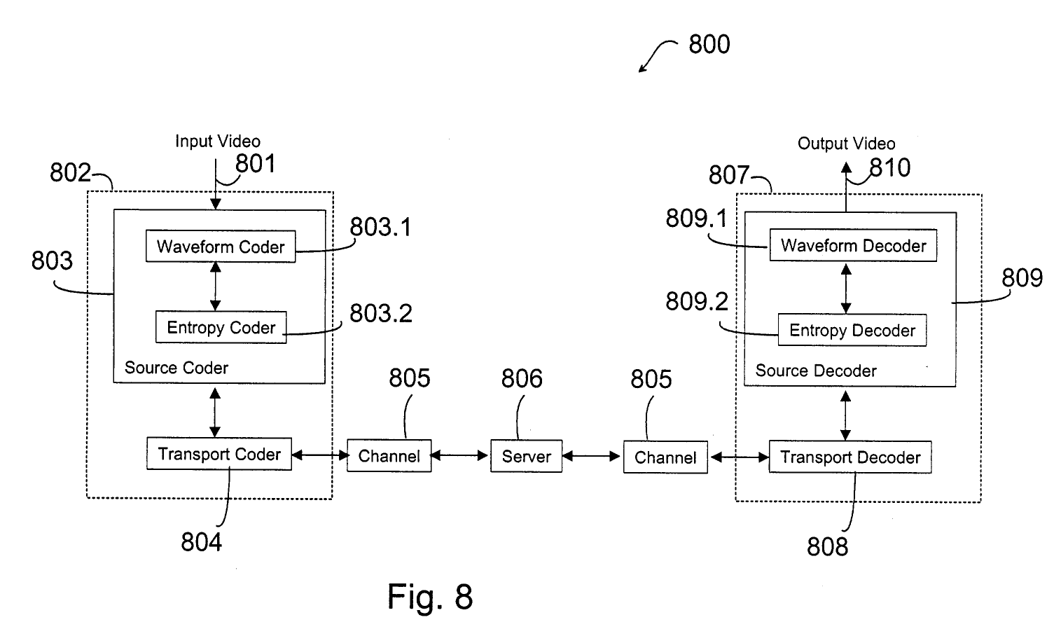

In the following the invention will be described in more detail with reference to the system of FIG. 5, the encoder 1 and optional hypothetical reference decoder (HRD) 5 of FIG. 6 and decoder 2 of FIG. 7. The pictures to be encoded can be, for example, pictures of a video stream from a video source 3, e.g. a camera, a video recorder, etc. The pictures (frames) of the video stream can be divided into smaller portions such as slices. The slices can further be divided into blocks. In the encoder 1 the video stream is encoded to reduce the information to be transmitted via a transmission channel 4, or to a storage media (not shown). Pictures of the video stream are input to the encoder 1. The encoder has an encoding buffer 1.1 (FIG. 6) for temporarily storing some of the pictures to be encoded. The encoder 1 also includes a memory 1.3 and a processor 1.2 in which the encoding tasks according to the invention can be applied. The memory 1.3 and the processor 1.2 can be common with the transmitting device 6 or the transmitting device 6 can have another processor and/or memory (not shown) for other functions of the transmitting device 6. The encoder 1 performs motion estimation and/or some other tasks to compress the video stream. In motion estimation similarities between the picture to be encoded (the current picture) and a previous and/or latter picture are searched. If similarities are found the compared picture or part of it can be used as a reference picture for the picture to be encoded. In JVT the display order and the decoding order of the pictures are not necessarily the same, wherein the reference picture has to be stored in a buffer (e.g. in the encoding buffer 1.1) as long as it is used as a reference picture. The encoder 1 also inserts information on display order of the pictures into the transmission stream. In practice, either the timing information SEI message or timestamps external to the JVT syntax (such as RTP timestamps) can be used.

From the encoding process the encoded pictures are moved to an encoded picture buffer 1.2, if necessary. The encoded pictures are transmitted from the encoder 1 to the decoder 2 via the transmission channel 4. In the decoder 2 the encoded pictures are decoded to form uncompressed pictures corresponding as much as possible to the encoded pictures. Each decoded picture is buffered in the DPB 2.1 of the decoder 2 unless it is displayed substantially immediately after the decoding and is not used as a reference picture. Advantageously both the reference picture buffering and the display picture buffering are combined and they use the same decoded picture buffer 2.1. This eliminates the need for storing the same pictures in two different places thus reducing the memory requirements of the decoder 2.

The decoder 1 also includes a memory 2.3 and a processor 2.2 in which the decoding tasks according to the invention can be applied. The memory 2.3 and the processor 2.2 can be common with the receiving device 8 or the receiving device 8 can have another processor and/or memory (not shown) for other functions of the receiving device 8.

Encoding

Let us now consider the encoding-decoding process in more detail. Pictures from the video source 3 are entered to the encoder 1 and advantageously stored in the pre-encoding buffer 1.1. There are two main reasons for storing the pictures. First, pictures arriving after a picture to be encoded are analyzed in a bit rate control algorithm so that there would be no remarkable variations in the quality of the pictures. Second, the coding order of the pictures (and the decoding order) is different from the capture order of the pictures. This kind of arrangement can be effective on the compression efficiency point of view (for example, a PBBBP frame sequence in which the B frame in between two other B frames is a reference frame for the other two B frames) and/or on the error resilience point of view (intra picture postponement).

The encoding process is not necessarily started immediately after the first picture is entered to the encoder, but after a certain amount of pictures are available in the encoding buffer 1.1. Then the encoder 1 tries to find suitable candidates from the pictures to be used as the reference frames. The encoder 1 then performs the encoding to form encoded pictures. The encoded pictures can be, for example, predicted pictures (P), bi-predictive pictures (B), and/or intra-coded pictures (I). The intra-coded pictures can be decoded without using any other pictures, but other type of pictures need at least one reference picture before they can be decoded. Pictures of any of the above mentioned picture types can be used as a reference picture.

The encoder advantageously attaches two time stamps to the pictures: a decoding time stamp (DTS) and output time stamp (OTS). The decoder can use the time stamps to determine the correct decoding time and time to output (display) the pictures. However, those time stamps are not necessarily transmitted to the decoder or it does not use them.

The encoder 1 can form redundant coded pictures or redundant coded data partitions of the pictures to increase error resiliency. According to the present invention the encoder can form redundant pictures which do not contain all the necessary information to decode the picture but only some portion(s) of it. The encoder 1 can also form more than one different redundant coded data partitions for the same picture wherein the different redundant coded data partitions contain information from at least partly different areas of the picture. The smallest redundant coded picture consists preferably of a slice. The slice contains one or more macroblocks.

Preferably, the encoder 1 decides what pictures contain areas which should be redundantly coded. The criteria for the selection may vary in different embodiments and in different situations. For example, the encoder 1 may examine if there is a possible scene change between successive pictures or if there are, for some other reason, lot of changes between successive pictures. Respectively, the encoder 1 can examine whether there are changes in some portions of pictures to determine which parts of the pictures should be redundantly encoded. To decide this, the encoder 1 can, for example, examine the motion vectors to find out important regions and/or regions which are especially sensitive to transmission/decoding errors and form redundant coded data partitions of such regions.

There should be some indication in the transmission stream to indicate if there exist redundant slices in the stream. The indication is preferably inserted in the slice header of each slice and/or in the picture parameter set. One advantageous embodiment of the indication uses two syntax elements for redundant slices: the first syntax element is “redundant_slice flag” which resides in the picture parameter set, and the other syntax element is “redundant_pic_cnt” and it resides in slice header. The “redundant_pic_cnt” is optional and it is included in the slice header only when “redundant_slice_flag” in the referred picture parameter set is set to 1.

The semantics of the two syntax elements are as follows: redundant_slice_flag indicates the presence of the redundant_pic_cnt parameter in all slice headers referencing the picture parameter set. The picture parameter set can be common for more than one slice if all the parameters are equal for the slices. If the value of the redundant_slice_flag is true, then the slice headers of those slices which refer to this parameter set contain the second syntax element (redundant_pic_cnt).

The value of the redundant_pic_cnt is 0 for coded slices and data partitions belonging to the primary representation of the picture contents. The redundant_pic_cnt is greater than 0 for coded slices and data partitions that contain redundant coded representation of the picture contents. There should be no noticeable difference between the co-located areas of the decoded primary representation of the picture and any decoded redundant slices. Redundant slices and data partitions having the same value of redundant_pic_cnt belong to the same redundant picture. Decoded slices having the same redundant_pic_cnt shall not overlap. Decoded slices having a redundant_pic_cnt greater than 0 may not cover the entire picture area. The pictures may have a parameter called as nal_storage_idc. If the value of the nal_storage_idc in a primary picture is 0, the value of the nal_storage_idc in corresponding redundant pictures shall be 0. If the value of the nal_storage_idc in a primary picture is non-zero, the value of the nal_storage_idc in corresponding redundant pictures shall be non-zero.

The above described syntax design works well when data partitioning is not applied for redundant slices. However, when data partitioning is used, i.e. each redundant slice has three data partitions DPA, DPB and DPC, a further mechanism is needed to inform the decoder which redundant slice is in question. To achieve this, the redundant_pic_cnt is included, not only the slice header in DPA but also in slice headers of both DPB and DPC. If slice data partitioning is in use, slice data partition B and C have to be associated to the respective slice data partition A in order to enable decoding of the slice. Slice data partition A includes a slice_id syntax element whose value uniquely identifies a slice within a coded picture. Slice data partitions B and C include the redundant_pic_cnt syntax element if it is also present in the slice header included in the slice data partition A (which is conditional to the value of “redundant_slice flag” in the referred picture parameter set). The value of the redundant_pic_cnt syntax element is used to associate slice data partitions B and C to a particular primary or redundant coded picture. In addition to redundant_pic_cnt, slice data partitions B and C include the slice_id syntax element, which is used to associate the data partition with the respective data partition A of the same coded picture.

Transmission

The transmission and/or storing of the encoded pictures (and the optional virtual decoding) can be started immediately after the first encoded picture is ready. This picture is not necessarily the first one in decoder output order because the decoding order and the output order may not be the same.

When the first picture of the video stream is encoded the transmission can be started. The encoded pictures are optionally stored to the encoded picture buffer 1.2. The transmission can also start at a later stage, for example, after a certain part of the video stream is encoded.

In some transmission systems the number of transmitted redundant pictures depends inter alia on network conditions such as amount of traffic, bit error rate in a radio link, etc. In other words, all redundant pictures are not necessarily transmitted.

Decoding

Next, the operation of the receiver 8 will be described. The receiver 8 collects all packets belonging to a picture, bringing them into a reasonable order. The strictness of the order depends on the profile employed. The received packets are advantageously stored into the receiving buffer 9.1 (pre-decoding buffer). The receiver 8 discards anything that is unusable, and passes the rest to the decoder 2.

If the primary representation of the picture or part of it is lost or decoding error(s) exist, the decoder can use some of the redundant coded slices to decode the picture. The decoder 2 can send the slice id:s or some other information identifying the picture in question to the encoder 1. When the decoder 2 has all the necessary slices available it can start to decode the picture. It may happen that, despite of the usage of redundant coded data partitions, some slices may not be available at the decoder 2. In that case the decoder 2 can try e.g. some error recovery methods to diminish the effects of the error on picture quality, or the decoder 2 can discard the erroneous picture and use some previous picture instead.

The present invention can be applied in many kind of systems and devices. The transmitting device 6 including the encoder 1 and optionally the HRD 5 advantageously include also a transmitter 7 to transmit the encoded pictures to the transmission channel 4. The receiving device 8 include the receiver 9 to receive the encoded pictures, the decoder 2, and a display 10 on which the decoded pictures can be displayed. The transmission channel can be, for example, a landline communication channel and/or a wireless communication channel. The transmitting device and the receiving device include also one or more processors 1.2, 2.2 which can perform the necessary steps for controlling the encoding/decoding process of video stream according to the invention. Therefore, the method according to the present invention can mainly be implemented as machine executable steps of the processors. The buffering of the pictures can be implemented in the memory 1.3, 2.3 of the devices. The program code 1.4 of the encoder can be stored into the memory 1.3. Respectively, the program code 2.4 of the decoder can be stored into the memory 2.3.

1. A method for encoding pictures, wherein
primary coded pictures and redundant coded pictures of primary coded pictures are formed, each primary coded picture comprising essentially the same picture information as the respective redundant coded picture, and
at least one of the redundant coded pictures comprises picture information corresponding to only a part of the picture information of the respective primary coded picture.

2. The method according to claim 1 further comprising a transmission step for transmitting at least said primary coded pictures to a decoder.

3. The method according to claim 1, wherein the pictures to be encoded comprise slices, wherein said redundant coded pictures contain part of the slices of the primary coded picture.

4. The method according to claim 1, wherein the redundant coded pictures containing only a part of the respective primary coded picture are formed as redundant coded data portions.

5. The method according to claim 4, in which at least one parameter set is formed for the pictures, and a slice header is formed for each slice, wherein an indication whether a transmission stream contains slices of redundant coded data partitions is inserted into the parameter set, and a redundant_pic_cnt parameter is inserted into each slice header of the redundant coded data partitions.

6. A method for decoding pictures from a bitstream, wherein
primary coded pictures and redundant coded pictures of primary coded pictures are contained in the bitstream, the primary coded pictures having been formed using essentially the same picture information as what has been used to form the respective redundant coded pictures,
and at least one of the redundant coded pictures comprises picture information corresponding to only a part of the picture information of the respective primary coded picture;
detecting in the bitstream a parameter indicating that the coded picture information belongs to a redundant coded picture;
using the parameter to control the decoding of the coded picture information belonging to a redundant coded picture wherein the redundant coded picture information corresponds to only a part of the picture information used to form the respective primary coded picture.

7. The method according to claim 6 further comprising a receiving step for receiving at least said primary coded pictures.

8. The method according to claim 7 further comprising receiving said redundant coded pictures.

9. The method according to claim 8 comprising determining, if a primary coded pictures contain areas which can not be decoded, wherein the method comprising examining if the redundant coded pictures contain decodable information on the areas of the primary coded pictures which can not be decoded, and decoding redundant coded pictures found on the basis of the examination.

10. The method according to claim 9, in which at least one parameter set is formed for the pictures, and a slice header is formed for each slice, wherein an indication whether a transmission stream contains slices of redundant coded data partitions is inserted into the parameter set, and a redundant_pic_cnt parameter is inserted into each slice header of the redundant coded data partitions, wherein the indication and the redundant_pic_cnt parameter are used to distinguish between primary coded pictures and redundant coded pictures.

11. An encoder for encoding pictures, comprising encoding means for forming primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture.

12. A decoder for decoding pictures from a bitstream, the bitstream comprising:
primary coded pictures and redundant coded pictures of primary coded pictures, the primary coded pictures having been formed using essentially the same picture information as what has been used to form the respective redundant coded pictures,
and at least one of the redundant coded pictures comprises picture information corresponding to only a part of the picture information of the respective primary coded picture;
wherein the decoder comprising:
detecting means for detecting in the bitstream a parameter indicating that the coded picture information belongs to a redundant coded picture; and
controlling means using the parameter to control the decoding of the coded picture information belonging to a redundant coded picture wherein the redundant coded picture information corresponds to only a part of the picture information used to form the respective primary coded picture.

13. A transmitting device comprising an encoder for encoding pictures, comprising encoding means for forming primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture.

14. The transmitting device according to claim 13 further comprising a transmitter for transmitting at least said primary coded pictures to a decoder.

15. The transmitting device according to claim 13, wherein the pictures to be encoded encoded comprise slices, wherein said redundant coded pictures contain part of the slices of the primary coded picture.

16. The transmitting device according to claim 13, comprising means for forming at least one parameter set for the pictures, and a slice header for each slice, means for inserting an indication whether a transmission stream contains slices of redundant coded data partitions into the parameter set, and a redundant_pic_cnt parameter into each slice header of the redundant coded data partitions.

17. A receiving device comprising a decoder for decoding pictures from a bitstream, the bitstream comprising:
primary coded pictures and redundant coded pictures of primary coded pictures, the primary coded pictures having been formed using essentially the same picture information as what has been used to form the respective redundant coded pictures,
and at least one of the redundant coded pictures comprises picture information corresponding to only a part of the picture information of the respective primary coded picture;
wherein the decoder comprising:
detecting means for detecting in the bitstream a parameter indicating that the coded picture information belongs to a redundant coded picture; and
controlling means using the parameter to control the decoding of the coded picture information belonging to a redundant coded picture wherein the redundant coded picture information corresponds to only a part of the picture information used to form the respective primary coded picture.

18. A system comprising:
an encoder for encoding pictures, comprising encoding means for forming primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture;
a transmitter for transmitting at least said primary coded pictures to a decoder;
the decoder comprising:
detecting means for detecting in the bitstream a parameter indicating that the coded picture information belongs to a redundant coded picture; and
controlling means using the parameter to control the decoding of the coded picture information belonging to a redundant coded picture wherein the redundant coded picture information corresponds to only a part of the picture information used to form the respective primary coded picture.

19. A software program comprising machine executable steps for encoding pictures, comprising machine executable steps for forming:
primary coded pictures and redundant coded pictures of primary coded pictures, each primary coded picture comprising essentially the same picture information as the respective redundant coded picture, and
at least one of the redundant coded pictures comprises picture information corresponding to only a part of the picture information of the respective primary coded picture.

20. A software program comprising machine executable steps for decoding pictures from a bitstream, comprising:
primary coded pictures and redundant coded pictures of primary coded pictures are contained in the bitstream, the primary coded pictures having been formed using essentially the same picture information as what has been used to form the respective redundant coded pictures,
and at least one of the redundant coded pictures comprises picture information corresponding to only a part of the picture information of the respective primary coded picture;
wherein the software program comprising machine executable steps for:
detecting in the bitstream a parameter indicating that the coded picture information belongs to a redundant coded picture; and
using the parameter to control the decoding of the coded picture information belonging to a redundant coded picture wherein the redundant coded picture information corresponds to only a part of the picture information used to form the respective primary coded picture.

21. A storage medium for storing a software program comprising machine executable steps for encoding pictures, comprising machine executable steps for forming:
primary coded pictures and redundant coded pictures of primary coded pictures, each primary coded picture comprising essentially the same picture information as the respective redundant coded picture, and
at least one of the redundant coded pictures comprises picture information corresponding to only a part of the picture information of the respective primary coded picture.

22. A storage medium for storing a software program comprising machine executable steps for decoding pictures from a bitstream, comprising:
primary coded pictures and redundant coded pictures of primary coded pictures are contained in the bitstream, the primary coded pictures having been formed using essentially the same picture information as what has been used to form the respective redundant coded pictures,
and at least one of the redundant coded pictures comprises picture information corresponding to only a part of the picture information of the respective primary coded picture;
wherein the software program comprising machine executable steps for:
detecting in the bitstream a parameter indicating that the coded picture information belongs to a redundant coded picture; and
using the parameter to control the decoding of the coded picture information belonging to a redundant coded picture wherein the redundant coded picture information corresponds to only a part of the picture information used to form the respective primary coded picture.

23. A bitstream comprising primary coded pictures and redundant coded pictures of primary coded pictures, each primary coded picture comprising essentially the same picture information as the respective redundant coded picture, and at least one of the redundant coded pictures comprises picture information corresponding to only a part of the picture information of the respective primary coded picture.
